(19) United States
(12) Patent Application Publication
(10) Pub. No.: US 2016/0269634 A1
(43) Pub. Date: Sep. 15, 2016

(54) METHOD AND APPARATUS OF WORKING MODE CONTROL, AND ELECTRONIC DEVICE

(71) Applicant: SONY CORPORATION, Tokyo (JP)

(72) Inventors: Gang XU, Beijing (CN); Zhong LI, Beijing (CN); Zhannian GAO, Beijing (CN); Hairong HUANG, Beijing (CN); Hongxing YU, Beijing (CN); Tao ZHOU, Beijing (CN)

(21) Appl. No.: 14/411,703

(22) PCT Filed: Sep. 11, 2014
(86) PCT No.: PCT/IB2014/064413

§ 371 Date: Dec. 29, 2014

(30) Foreign Application Priority Data
Jan. 24, 2014 (CN) 201410035023.6

(51) Int. Cl. H04N 5/232

(52) U.S. Cl. CPC H04N 5/23245; H04N 5/23241; H04N 5/23229

(57) ABSTRACT

The embodiments of the present invention provide a method and an apparatus for controlling a work mode, and an electronic device, wherein the method comprises: capturing, by an electronic device, at least two images; calculating a difference between the at least two images; and comparing the difference between the at least two images with a predetermined first threshold, and determining whether to switch the work mode of the electronic device according to a comparison result. Thus the electronic device automatically performs the mode switching without influencing the user's shooting experience.

### TECHNICAL FIELD

The present invention relates to image processing technologies, and particularly, to a method and an apparatus for controlling a work mode, and an electronic device.

### BACKGROUND ART

With the development of technologies, more and more electronic devices have a shooting function. Currently, there are mainly two conventional methods for a mode switching (e.g., quitting a shooting mode in order to save power): one is to set a timer in the electronic device, so that the electronic device automatically performs the mode switching (e.g., quitting the shooting mode) if a user does not shoot a picture within a predetermined time such as 30 seconds; and the other is that the user presses a RETURN key or HOME key on the electronic device, so as to manually perform the mode switching on the electronic device.

To be noted, the above introduction to the technical background is just made for the convenience of clearly and completely describing the technical solutions of the present invention, and to facilitate the understanding of a person skilled in the art. It shall not be deemed that the above technical solutions are known to a person skilled in the art just because they have been illustrated in the Background section of the present invention.

### SUMMARY

However, the inventor discovers that in order to find a scene better during a picture shooting, the user may attempt different viewing angles. If the aforementioned first method is adopted to perform the mode switching, the electronic device automatically quits the shooting mode when the shooting key is not pressed due to a long scene-finding time; and if the user wants to continue the shooting, the shooting function shall be restarted, which influences the user's shooting experience.

If the aforementioned second method is adopted, the mode switching cannot be automatically performed after the shooting mode is started. For example, if the user forgets to quit the shooting mode (e.g., the electronic device is directly placed in the pocket or on the table), the electronic device always runs, and its power is wasted.

The embodiments of the present invention provide a method and an apparatus for controlling a work mode, and an electronic device, so that the electronic device automatically performs the mode switching without influencing the user's shooting experience.

According to an aspect of the embodiments of the present invention, a method for controlling a work mode is provided, including:

capturing, by an electronic device, at least two images;

calculating a difference between the at least two images; and

comparing the difference between the at least two images with a predetermined first threshold, and determining whether to switch the work mode of the electronic device according to a comparison result.

According to another aspect of the embodiments of the present invention, wherein determining whether to switch the work mode of the electronic device according to the comparison result includes: switching the work mode of the electronic device when the difference between the at least two images does not exceed the first threshold; and not switching the work mode of the electronic device when the difference between the at least two images exceeds the first threshold.

According to another aspect of the embodiments of the present invention, wherein the electronic device captures the at least two images within a first predetermined time or when a predetermined condition is met.

According to another aspect of the embodiments of the present invention, wherein capturing the at least two images within the first predetermined time by the electronic device includes:

capturing an image at an interval of a second predetermined time within the first predetermined time.

According to another aspect of the embodiments of the present invention, wherein calculating the difference between the at least two images includes:

after capturing a first image and when a second image captured before the second predetermined time exists, calculating a difference between the first image and the second image.

According to another aspect of the embodiments of the present invention, wherein the method further includes:

triggering a timer to start a timing when the calculated difference between the first image and the second image does not exceed the first threshold and the timer is in a non-timing state;

resetting the timer into the non-timing state when the calculated difference between the first image and the second image exceeds the first threshold;

continuing the timing by the timer when the calculated difference between the first image and the second image does not exceed the first threshold and the timer is in a timing state; and

switching the work mode of the electronic device when the timing of the timer exceeds a second threshold.

According to another aspect of the embodiments of the present invention, wherein the difference between the at least two images is calculated according to histograms of the images, Perceptual Hash Algorithm (PHA), image difference algorithm, image pixel color difference algorithm, Cellular Neural Network (CNN) algorithm, local wavelet descriptor algorithm, Local Binary Pattern (LBP) descriptor algorithm, image pixel grey level related algorithm, or Weber difference descriptor algorithm.

According to another aspect of the embodiments of the present invention, wherein the electronic device captures the images under a shooting mode;

switching the work mode of the electronic device includes: turning off the shooting mode, or switching from a normal shooting mode into a sleep mode or a power saving mode.

According to another aspect of the embodiments of the present invention, wherein the method further includes:

judging whether detection information detected by a sensor reaches a predetermined threshold;

capturing the at least two images by the electronic device when the predetermined threshold is reached.

According to another aspect of the embodiments of the present invention, wherein the method further includes:

judging whether a predetermined object is captured;

capturing the at least two images by the electronic device when the predetermined object is not captured.

According to another aspect of the embodiments of the present invention, an apparatus for controlling a work mode is provided, including:

an capturing unit configured to capture at least two images;

a calculating unit configured to calculate a difference between the at least two images captured by the capturing unit; and

a switching unit configured to compare the difference between the at least two images with a predetermined first threshold, and determine whether to switch the work mode of the electronic device according to a comparison result.

According to another aspect of the embodiments of the present invention, wherein the switching unit is configured to: switch the work mode of the electronic device when the difference between the at least two images does not exceed the first threshold; and not switch the work mode of the electronic device when the difference between the at least two images exceeds the first threshold.

According to another aspect of the embodiments of the present invention, wherein the capturing unit is configured to capture the at least two images within a first predetermined time or when a predetermined condition is met.

According to another aspect of the embodiments of the present invention, wherein the capturing unit further includes:

a first capturing module configured to capture an image at an interval of a second predetermined time within the first predetermined time.

According to another aspect of the embodiments of the present invention, wherein the calculating unit further includes:

a first calculating module configured to calculate, after the first capturing module captures a first image and when a second image captured before the second predetermined time exists, a difference between the first image and the second image.

According to another aspect of the embodiments of the present invention, wherein the apparatus further includes:

a triggering unit configured to trigger a timer to start a timing when the difference between the first image and the second image calculated by the first calculating module does not exceed the first threshold and the timer is in a non-timing state;

a resetting unit configured to reset the timer into the non-timing state when the difference between the first image and the second image calculated by the first calculating module exceeds the first threshold;

the switching unit is further configured to switch the work mode of the electronic device when the timing of the timer exceeds a second threshold.

According to another aspect of the embodiments of the present invention, wherein the capturing unit is specifically configured to capture the images under a shooting mode;

switching the work mode of the electronic device by the switching unit specifically includes: turning off the shooting mode, or switching from a normal shooting mode into a sleep mode or a power saving mode.

According to another aspect of the embodiments of the present invention, wherein the apparatus further includes:

a first judging unit configured to judge whether detection information detected by a sensor reaches a predetermined threshold; and

the capturing unit captures the at least two images when a judgment result of the first judging unit shows that the predetermined threshold is reached.

According to another aspect of the embodiments of the present invention, wherein the apparatus further includes:

a second judging unit configured to judge whether a predetermined object is captured; and

the capturing unit captures at least two images when a judgment result of the second judging unit shows that the predetermined object is not captured.

According to another aspect of the embodiments of the present invention, an electronic device is provided, including the aforementioned apparatus for controlling a work mode.

The embodiments of the present invention have the following beneficial effect: the calculated difference between at least two images is compared with a predetermined first threshold, and it is determined whether to switch the work mode of the electronic device according to the comparison result, so that the electronic device automatically switches the work mode (e.g., quitting the shooting mode or switching into the power saving mode) without influencing the user's shooting experience.

These and other aspects of the present invention will be clear with reference to the subsequent descriptions and drawings, which specifically disclose the particular embodiments of the present invention to indicate some implementations of the principle of the present invention. But it shall be appreciated that the scope of the present invention is not limited thereto, and the present invention includes all the changes, modifications and equivalents falling within the scope of the spirit and the connotations of the accompanying claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, step or component, not excluding the presence or addition of one or more other features, elements, steps or components or combinations thereof.

Many aspects of the present invention will be understood better with reference to the following drawings. The components in the drawings are not necessarily drawn in proportion, and the emphasis lies in clearly illustrating principles of the present invention. For the convenience of illustrating and describing some portions of the present invention, corresponding portions in the drawings may be enlarged, e.g., being more enlarged relative to other portions than the situation in the exemplary device practically manufactured according to the present invention. The parts and features illustrated in one drawing or embodiment of the present invention may be combined with the parts and features illustrated in one or more other drawings or embodiments. In addition, the same reference signs denote corresponding portions throughout the drawings, and they can be used to denote the same or similar portions in more than one embodiment.

### BRIEF DESCRIPTION OF DRAWINGS

The included drawings provide further understanding of the present invention, and they constitute a part of the Specification. The drawings illustrate the preferred embodiments of the present invention, and explain principles of the present invention together with the text, wherein the same element is always denoted with the same reference sign.

FIG. 1 is a flowchart of a method for controlling a work mode according to Embodiment 1 of the present invention.

FIG. 2 is another flowchart of a method for controlling a work mode according to Embodiment 1 of the present invention.

FIG. 3 is a schematic diagram of images subsequently captured in a first predetermined time by an electronic device according to Embodiment 1 of the present invention.

FIG. 4 is still another flowchart of a method for controlling a work mode according to Embodiment 1 of the present invention.

FIG. 5 is a schematic diagram of an apparatus for controlling a work mode according to Embodiment 2 of the present invention.

FIG. 6 is another schematic diagram of an apparatus for controlling a work mode according to Embodiment 2 of the present invention.

FIG. 7 is a schematic block diagram of a system construction of an electronic device according to Embodiment 3 of the present invention.

### DESCRIPTION OF EMBODIMENTS

The interchangeable terms “electronic device” and “electronic apparatus” include a portable radio communication device. The term “portable radio communication device”, which is hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, portable communication apparatus, etc.

In the present application, the embodiments of the present invention are mainly described with respect to a portable electronic apparatus in the form of a mobile phone (also referred to as “cellular phone”). However, it shall be appreciated that the present invention is not limited to the case of the mobile phone and it may relate to any type of appropriate electronic device, such as media player, gaming device, PDA, computer, digital camera, tablet computer, etc.

### Embodiment 1

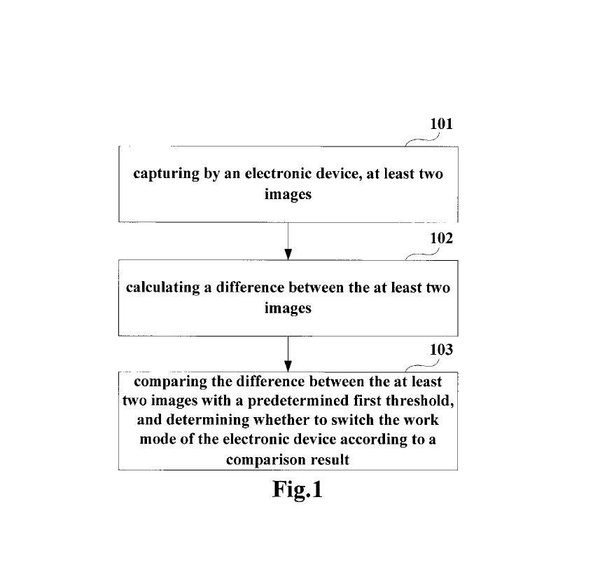

Embodiment 1 of the present invention provides a method for controlling a work mode according to Embodiment 1 of the present invention. FIG. 1 is a flowchart of a method for controlling a work mode according to Embodiment 1 of the present invention. As illustrated in FIG. 1, the method includes:

Step 101: capturing, by an electronic device, at least two images;

Step 102: calculating a difference between the at least two images;

Step 103: comparing the difference between the at least two images with a predetermined first threshold, and determining whether to switch the work mode of the electronic device according to a comparison result.

In the embodiment, the electronic device for example may be, but not limited to, a camera, a smart phone, a tablet computer, etc. The electronic device can control a camera, wherein the camera may be provided in the electronic device, such as a front-facing camera of the smart phone, or may be removably integrated with the electronic device through an interface. In addition, the camera may be connected to the electronic device wiredly or wirelessly, and for example it may be controlled by the electronic device through WiFi. The present invention is not limited thereto, and the camera may be connected to the electronic device in other manners. Next, the description is just made through an example where the camera is provided in the electronic device.

In the embodiment, the work mode of the electronic device may be a picture-shooting mode, a video-shooting mode, a preview mode, an edition mode, a sending mode, a sleep mode/a power saving mode, etc. The work modes may be switched into each other, and for their specific contents, please refer to the prior art. The present invention is not limited thereto, and for example other work modes may also be adopted. In addition, the switching of the work mode also includes quitting the current work mode, switching from the shooting mode to the sleep mode/power saving mode, switching from the shooting mode to the preview mode, etc. Next, the description is just made with respect to the switching when the electronic device is in the shooting mode.

In the embodiment, within the first predetermined time or when a predetermined condition is met, the electronic device can capture at least two images. The predetermined condition may be, but not limited to, that detection information detected by a sensor reaches a predetermined threshold.

For example, a first image may be captured in a case where an acceleration sensor detects that the acceleration of the electronic device reaches A, and a second image may be captured in a case where the acceleration reaches B. Or, a first image may be captured in a case where a humidity sensor detects that the humidity of the electronic device reaches C, and a second image may be captured in a case where the humidity reaches D.

Next, the description is just made through an example where at least two images are captured within a predetermined time.

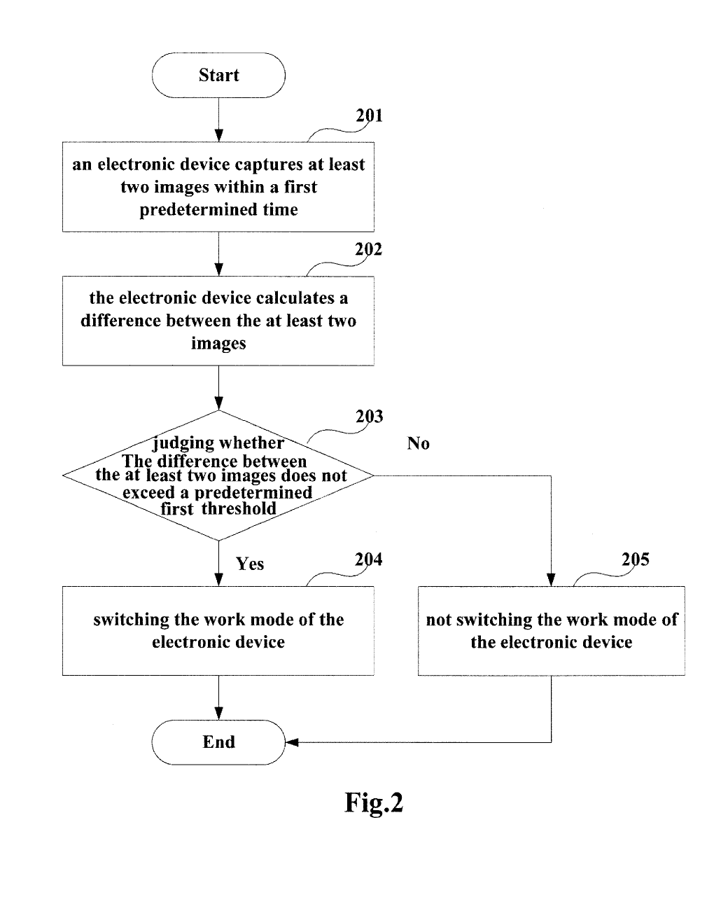

FIG. 2 is another flowchart of a method for controlling a work mode according to Embodiment 1 of the present invention. As illustrated in FIG. 2, the method includes:

Step 201: an electronic device captures at least two images within a first predetermined time;

Step 202: the electronic device calculates a difference between the at least two images;

Step 203: the electronic device judges whether the difference between the at least two images does not exceed a predetermined first threshold; if so, performing step 204, otherwise performing step 205;

Step 204: switching the work mode of the electronic device;

Step 205: not switching the work mode of the electronic device.

In step 201, the electronic device captures at least two images within the first predetermined time. For example, the electronic device in the shooting mode automatically captures the images within the first predetermined time. The first predetermined time may be preset on-demand in implementation, such as 30 seconds, 40 seconds, etc.

In step 202, the electronic device may calculate a difference between the at least two images. For example, the difference may be calculated based on different brightness or RGB values of two images. The present invention is not limited thereto, and any known parameter can be used.

In the embodiment, the difference between the at least two images may be calculated according to histograms of the images, Perceptual Hash Algorithm (PHA), image difference algorithm (image brightness histogram difference algorithm), image pixel color difference algorithm, Cellular Neural Network (CNN) algorithm, Gabor local wavelet descriptor algorithm, Local Binary Pattern (LBP) descriptor algorithm, image pixel grey level related algorithm, or Weber difference descriptor algorithm But the embodiment is not limited thereto, and for example other algorithms may also be adopted to calculate the difference between the images.

In step 204, when the difference between the at least two images does not exceed a first threshold, it means that the image taken in real-time is not changed obviously, e.g., to an obvious extent or predetermined extent, thus the work mode of the electronic device may be switched. For example, switching the work mode of the electronic device may include: enabling the electronic device to quit the shooting mode, or switching the electronic device from the shooting mode to the sleep mode or preview mode, but the embodiment is not limited thereto.

Thus, when the difference between the at least two images captured within the predetermined time does not exceed the first threshold, the work mode of the electronic device is switched, so that the electronic device automatically switches the work mode (e.g., quitting the shooting mode), while saving the power of the electronic device and prolonging the service life thereof.

In step 205, when the difference between the at least two images exceeds the first threshold, the work mode of the electronic device may be not switched. Thus a mode switching is not performed for the electronic device being used (e.g., a camera which is taking a scene), and the user's shooting experience will not be influenced.

Next, the present invention will be further described by setting a timer. Through the following implementation, the judgment can be made more accurately to further improve the user's shooting experience.

In one implementation of the embodiment, the electronic device may capture an image at an interval of a second predetermined time within the first predetermined time, wherein the second predetermined time is less than or equal to the first predetermined time, and may be preset on-demand in implementation, such as 5 seconds, 10 seconds, etc. The embodiment is not limited thereto, for example, the second predetermined time may be changed according to the number of shots or recordings of the captured images, i.e., the electronic device may capture the images at unequal intervals within the first predetermined time.

In the implementation, calculating the difference between the at least two images may include: after capturing an image (referred to as a first image) and when a neighbor image (referred to as a second image) captured before the second predetermined time exists, calculating the difference between the image and the neighbor image.

In the implementation, when the calculated difference between the image and the neighbor image does not exceed the first threshold and the timer is in a non-timing state, triggering the timer to start a timing; and when the timing of the timer exceeds a second threshold, switching the work mode of the electronic device.

In the implementation, when the calculated difference between the image and the neighbor image exceeds the first threshold, resetting the timer into the non-timing state; and when the calculated difference between the image and the neighbor image does not exceed the first threshold and the timer is in a timing state, the timer continues the timing.

The timer may be provided inside or outside the electronic device, and be connected to the electronic device wiredly or wirelessly. The first threshold and the second threshold may be preset on-demand, e.g., as desired by the user, in implementation. For example, the first threshold may be set as that the change of each gray level in the image histogram does not exceed 10%, or the gray level change above a predetermined percentage does not exceed 10%. The second threshold may be equal to the first predetermined time, such as 30 seconds. The timer being reset into the non-timing state for example may be that the timer is cleared, and the timer being in the timing state for example may be that the timer is non-zero, which is just exemplary herein, and the embodiment is not limited thereto.

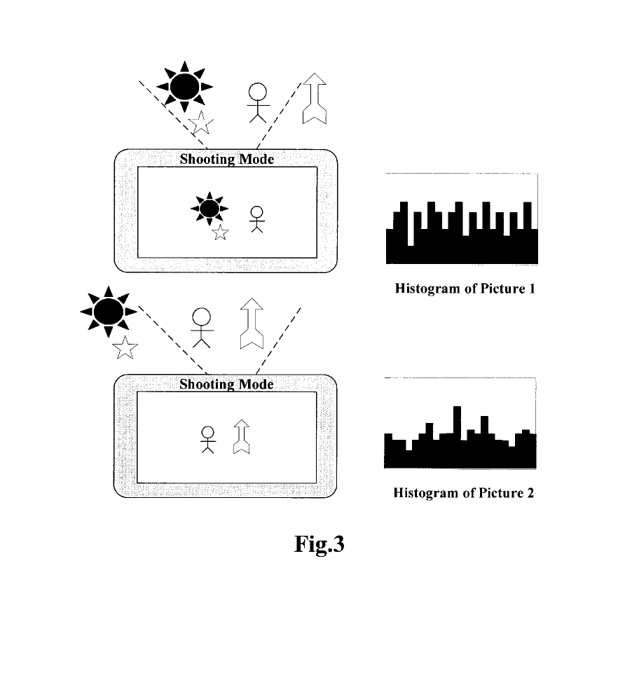

FIG. 3 is a schematic diagram of images subsequently captured in a first predetermined time by an electronic device according to Embodiment 1 of the present invention. As illustrated in FIG. 3, within the first predetermined time (e.g., 30 seconds), at least two images (pictures 1 and 2) can be captured under the shooting mode. Since the shooting angle is changed, the images displayed on the liquid crystal display under the shooting mode are also changed, thereby forming pictures 1 and 2 which have different histograms.

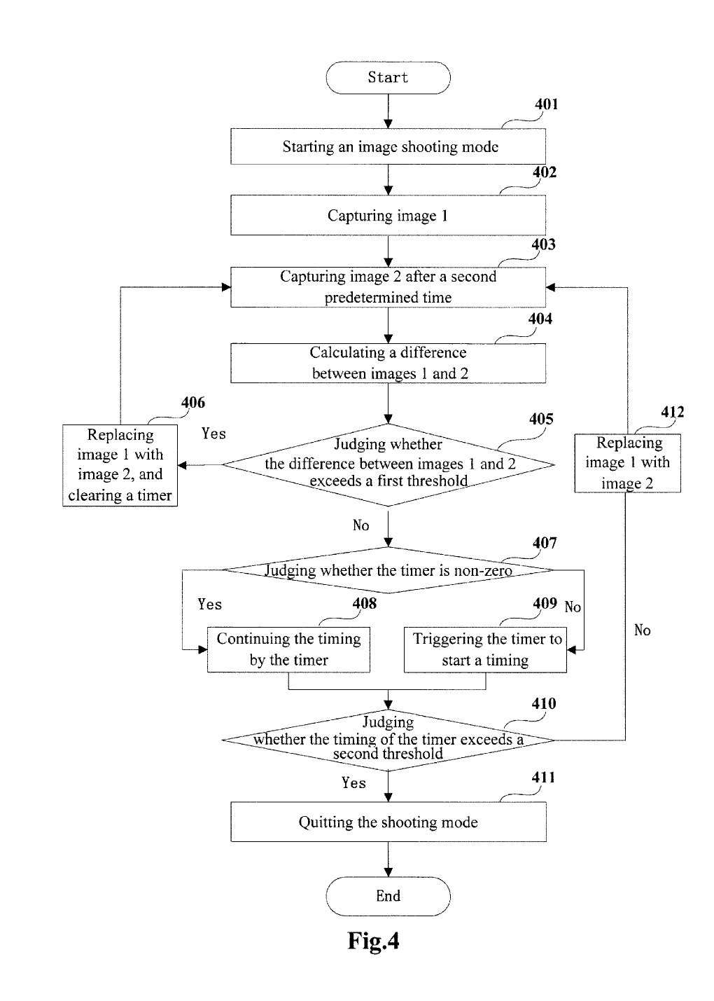

FIG. 4 is still another flowchart of switching a work mode according to Embodiment 1 of the present invention. As illustrated in FIG. 4, the method includes:

Step 401: starting an image shooting mode;

Step 402: capturing image 1;

Step 403: capturing image 2 after a second predetermined time;

Step 404: calculating a difference between images 1 and 2;

Step 405: judging whether the difference between images 1 and 2 exceeds a first threshold; if so, performing step 406, otherwise performing step 407;

For example, as illustrated in FIG. 3, the histogram distributions of images 1 and 2 can be calculated respectively. If the percentage of the gray levels having the difference exceeds a threshold, performing step 407;

Step 406: replacing image 1 with image 2, clearing a timer, and returning to step 403; in the embodiment, if the difference between images 1 and 2 exceeds the first threshold, it means that the shooting angle is changed, and the user might still adjust the shooting angle, thus the timer can be reset, i.e., the timer is cleared.

Step 407: judging whether the timer is non-zero, and if so, performing step 408, otherwise performing step 409;

Step 408: continuing the timing by the timer;

Step 409: triggering the timer to start a timing;

Step 410: judging whether the timing of the timer exceeds a second threshold, and if so, performing step 411, otherwise performing step 412;

Step 411: quitting the shooting mode;

Step 412: replacing image 1 with image 2, and returning to step 403.

In the implementation, the shooting time may be accumulated through the second predetermined time and the timer, so as to more accurately judge whether the work mode shall be switched. In addition, the shooting mode can be quitted automatically, thereby saving the power of the electronic device, and prolonging the service life thereof.

In the embodiment, the user may set different first predetermined time, second predetermined time, first threshold and second threshold on-demand in implementation or as desired or required for the current condition or implementation. In addition, the work mode may be a preview mode or a shooting mode, and the switching of the work mode may be quitting the shooting mode, or switching the shooting mode into the sleep mode/power saving mode. Moreover, the judgment of the difference between the images is not restricted to using the histograms. Those descriptions are just exemplary, and the embodiment is not limited thereto.

In one implementation, before step 101, 201 or 402, the method may further include: judging whether detection information detected by a sensor reaches a predetermined threshold; and if so, performing step 101, 201 or 402.

The electronic device may have various sensors, which may be, but not limited to, one or arbitrary combinations of an acceleration sensor, a proximity sensor, a temperature sensor, a speed sensor, a barometric pressure sensor, a geomagnetic sensor, a deformation sensor, a humidity sensor and a light sensor. Next, the description is just made by taking the speed sensor as an example.

For example, the electronic device is a driving recorder, and its speed sensor detects the speed. If the speed sensor detects that the speed is lower than a predetermined threshold, e.g., 1 KM/h, step 101, 201 or 402 may be performed to judge whether the mode shall be switched. Thus, the mode switching condition may be further set to improve the judgment accuracy.

In another implementation, before step 101, 201 or 402, the method may further include: judging whether a predetermined object is captured, and if not, performing step 101, 201 or 402.

In this functioning or operating of the electronic device the predetermined object may be a particular person, a particular landscape, etc. The electronic device may capture the predetermined object from the image taken in real-time based on the mode recognition technology.

For example, the electronic device is a camera used to shoot the sunrise, and the rising sun may be registered or identified as the predetermined object. When a sun does not occur in the image taken in real-time by the electronic device, step 101, 201 or 402 may be performed to judge whether the mode shall be switched. Thus, the mode switching condition may be further set to improve the judgment accuracy.

As can be seen from the above method of the embodiment, the calculated difference between the at least two images is compared with the predetermined first threshold, and it is determined whether to switch the work mode of the electronic device according to the comparison result, so that the electronic device automatically switches the work mode (e.g., quitting the shooting mode or switching into the power saving mode) without influencing the user's shooting experience.

### Embodiment 2

Embodiment 2 of the present invention further provides an apparatus for controlling a work mode, which is applied to an electronic device provided with a camera. As the apparatus solves the problem in a principle similar to the method of Embodiment 1, for its implementation, please refer to the implementation of the method of Embodiment 1, and the repeated portions are omitted.

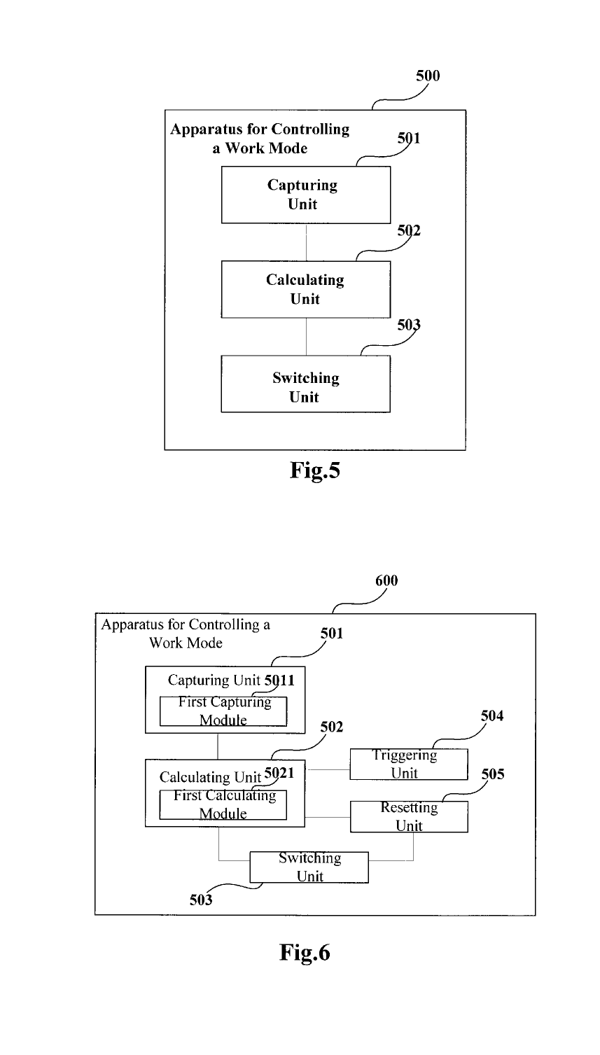

FIG. 5 is a schematic diagram of an apparatus for controlling a work mode according to Embodiment 2 of the present invention. As illustrated in FIG. 5, the apparatus 500 includes an capturing unit 501, a calculating unit 502 and a switching unit 503, wherein,

the capturing unit 501 is configured to capture at least two images;

the calculating unit 502 is configured to calculate a difference between the at least two images captured by the capturing unit 501; and

the switching unit 503 is configured to compare the difference between the at least two images with a predetermined first threshold, and determine whether to switch the work mode of the electronic device according to a comparison result.

In the embodiment, the switching unit 503 may be configured to switch the work mode of the electronic device when the difference between the at least two images does not exceed the first threshold; and not to switch the work mode of the electronic device when the difference between the at least two images exceeds the first threshold. The capturing unit 501 may be configured to capture the at least two images within the first predetermined time or when the predetermined condition is met.

FIG. 6 is another schematic diagram of an apparatus for controlling a work mode according to Embodiment 2 of the present invention. As illustrated in FIG. 6, the apparatus 600 includes a capturing unit 501, a calculating unit 502 and a switching unit 503 mentioned above.

In the embodiment, the capturing unit 501 further includes a first capturing module 5011 configured to capture an image at an interval of a second predetermined time within the first predetermined time.

The calculating unit 502 further includes a first calculating module 5021 configured to calculate, after the first capturing module 5011 captures an image and when a neighbor image captured before the second predetermined time exists, a difference between the image and the neighbor image.

In the embodiment, the apparatus for controlling the work mode may further include:

a triggering unit 504 configured to trigger a timer to start a timing when the difference between the image and the neighbor image calculated by the first calculating module 5021 does not exceed the first threshold and the timer is in a non-timing state.

The switching unit 503 switches the work mode of the electronic device when the timing of the timer exceeds a second threshold.

In the embodiment, the apparatus for controlling the work mode may further include:

a resetting unit 505 configured to reset the timer into the non-timing state when the difference between the image and the neighbor image calculated by the first calculating module 5021 exceeds the first threshold.

In the embodiment, the calculating unit 501 may calculate the difference between the at least two images according to histograms of the images, Perceptual Hash Algorithm (PHA), image difference algorithm (image brightness histogram difference algorithm), image pixel color difference algorithm, Cellular Neural Network (CNN) algorithm, Gabor local wavelet descriptor algorithm, Local Binary Pattern (LBP) descriptor algorithm, image pixel grey level related algorithm, or Weber difference descriptor algorithm.

In the embodiment, the work mode of the electronic device may be a picture-shooting mode, a video-shooting mode, a preview mode, an edition mode, a sending mode, a sleep mode/a power saving mode, etc. The work modes may be switched into each other, and for their specific contents, please refer to the prior art. The present invention is not limited thereto, and for example other work mode may also be adopted. In addition, the switching of the work mode also includes quitting the current work mode, switching from the shooting mode to the sleep mode/power saving mode, switching from the shooting mode to the preview mode, etc.

In one implementation, the apparatus for controlling the work mode may further include: a first judging unit configured to judge whether detection information detected by a sensor reaches a predetermined threshold. In addition, the capturing unit 501 is further configured to capture at least two images when a judgment result of the first judging unit shows that the predetermined threshold is reached.

In another implementation, the apparatus for controlling the work mode may further include: a second judging unit configured to judge whether a predetermined object is captured. In addition, the capturing unit 501 is further configured to capture at least two images when a judgment result of the second judging unit shows that the predetermined object is not captured.

As can be seen from the above apparatus of the embodiment, the calculated difference between at least two images is compared with the predetermined first threshold, and it is determined whether to switch the work mode of the electronic device according to the comparison result, so that the electronic device automatically switches the work mode (e.g., quitting the shooting mode or switching into the power saving mode) without influencing the user's shooting experience.

### Embodiment 3

Embodiment 3 of the present invention further provides an electronic device, which may be, but not limited to, a cellular phone, a photo camera, a video camera, a tablet computer, etc. In the embodiment, the electronic device may include the apparatus for controlling the work mode according to Embodiment 2, with the content thereof incorporated herein, and the repeated portions are omitted.

In the embodiment, the electronic device may be, but not limited to, a mobile terminal, a driving recorder, a wearable device, etc. Next, the description is made by taking the mobile terminal as an example.

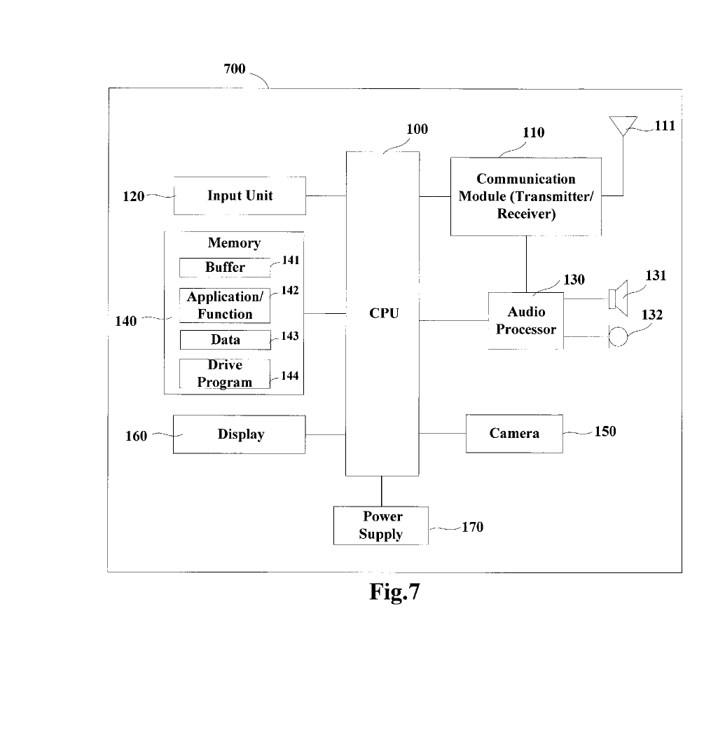

FIG. 7 is a schematic block diagram of a system construction of an electronic device 700 according to Embodiment 3 of the present invention. As illustrated in FIG. 7, the electronic device 700 may include a Central Processing Unit (CPU) 100 and a memory 140 coupled to the CPU 100. To be noted, the drawing is exemplary, and other type of structure may also be used to supplement or replace the structure, so as to realize the telecom function or other function.

In one implementation, the control function of the work mode may be integrated into the CPU 100. In which, the CPU 100 may be configured to perform controls of capturing at least two images; calculating a difference between the at least two images; comparing the difference between the at least two images with a predetermined first threshold, and determining whether to switch the work mode of the electronic device according to a comparison result.

In which, determining whether to switch the work mode of the electronic device according to the comparison result includes: switching the work mode of the electronic device when the difference between the at least two images does not exceed the first threshold; and not switching the work mode of the electronic device when the difference between the at least two images exceeds the first threshold.

In which, the at least two images may be captured within the first predetermined time or when a predetermined condition is met. Capturing the at least two images within the first predetermined time includes: capturing an image at an interval of a second predetermined time within the first predetermined time. Calculating the difference between the at least two images includes: after capturing a first image and when a second image captured before the second predetermined time exists, calculating a difference between the first image and the second image. A timer or timing function may be provided by the CPU and appropriate software and/or by another device.

The CPU 100 may be further configured to perform controls of triggering a timer to start a timing when the calculated difference between the first image and the second image does not exceed the first threshold and the timer is in a non-timing state; and switching the work mode of the electronic device when the timing of the timer exceeds a second threshold.

The CPU 100 may be further configured to perform controls of resetting the timer into the non-timing state when the calculated difference between the first image and the second image exceeds the first threshold; and continuing the timing by the timer when the calculated difference between the first image and the second image does not exceed the first threshold and the timer is in a timing state.

In which, the difference between the at least two images may be calculated according to histograms of the images, Perceptual Hash Algorithm (PHA), image difference algorithm, image pixel color difference algorithm, Cellular Neural Network (CNN) algorithm, local wavelet descriptor algorithm, Local Binary Pattern (LBP) descriptor algorithm, image pixel grey level related algorithm, or Weber difference descriptor algorithm.

The CPU 100 may be further configured to perform controls of capturing the images by the electronic device under the shooting mode; and switching the work mode of the electronic device includes: turning off the shooting mode, or switching from the normal shooting mode into a sleep mode or a power saving mode.

In another implementation, the apparatus for controlling the work mode may be configured separately from the CPU 100. For example, the apparatus for controlling the work mode may be configured as a chip connected to the CPU 100, so as to realize the control function of the work mode under the control of the CPU.

As illustrated in FIG. 7, the electronic device 700 may further include a communication module 110, an input unit 120, an audio processing unit 130, a display 160 and a power supply 170. To be noted, the electronic device 700 does not necessarily include all the parts illustrated in FIG. 7, and it may also include parts not illustrated in FIG. 7, please refer to the prior art.

As illustrated in FIG. 7, the CPU 100 (sometimes referred to as controller or operation control, including a microprocessor or other processor device and/or logic device) receives an input and controls the operations of respective parts of the electronic device 700.

In which, the memory 140 may be a buffer, a flash memory, a hard drive, a removable medium, a volatile memory, a nonvolatile memory or one or more of other appropriate means to store the failure related information, and store and execute a program related to the information. In addition, the CPU 100 may execute the program stored by the memory 140, so as to realize an information storage or processing.

The input unit 120 provides an input to the CPU 100. The input unit 120 for example is a key or touch input means. The camera 150 captures image data and supplies the captured image data to the CPU 100 for a conventional usage, such as storage, transmission, etc. The power supply 170 supplies electric power to the electronic device 700. The display 160 displays objects such as images and texts. The display may be, but not limited to, an LCD.

The memory 140 may be a solid state memory, such as Read Only Memory (ROM), Random Access Memory (RAM), SIM card, etc., or a memory which stores information even if the power is off, which can be selectively erased and provided with more data, and the example of such a memory is sometimes called as EPROM, etc. The memory 140 also may be a certain device of other type. The memory 140 includes a buffer memory 141 (sometimes referred to as buffer). The memory 140 may include an application/function storage section 142 which stores application programs and function programs or performs the operation procedure of the electronic device 700 via the CPU 100.

The memory 140 may further include a data storage section 143 which stores data such as contacts, digital data, pictures, sounds and/or any other data used by the electronic device. A drive program storage section 144 of the memory 140 may include various drive programs of the electronic device for performing the communication function and/or other functions (e.g., message transfer application, address book application, etc.) of the electronic device.

The communication module 110 is a transmitter/receiver 110 which transmits and receives signals via an antenna 111. The communication module (transmitter/receiver) 110 is coupled to the CPU 100, so as to provide an input signal and receive an output signal, which may be the same as the situation of conventional mobile communication terminal.

Based on different communication technologies, the same electronic device may be provided with a plurality of communication modules 110, such as cellular network module, Bluetooth module and/or wireless local area network (WLAN) module. The communication module (transmitter/receiver) 110 is further coupled to a speaker 131 and a microphone 132 via an audio processor 130, so as to provide an audio output via the speaker 131, and receive an audio input from the microphone 132, thereby performing the normal telecom function. The audio processor 130 may include any suitable buffer, decoder, amplifier, etc. In addition, the audio processor 130 is further coupled to the CPU 100, so as to locally record sound through the microphone 132, and play the locally stored sound through the speaker 131.

The embodiment of the present invention further provides a computer readable program, which when being executed in an electronic device, enables a computer to perform the method for controlling the work mode according to Embodiment 1 in the electronic device.

The embodiment of the present invention further provides a storage medium storing a computer readable program, wherein the computer readable program enables a computer to perform the method for controlling the work mode according to Embodiment 1 in an electronic device.

The preferred embodiments of the present invention are described as above with reference to the drawings. Many features and advantages of those embodiments are apparent from the detailed Specification, thus the accompanied claims intend to cover all such features and advantages of those embodiments which fall within the true spirit and scope thereof. In addition, since numerous modifications and changes are easily conceivable to a person skilled in the art, the embodiments of the present invention are not limited to the exact structures and operations as illustrated and described, but cover all suitable modifications and equivalents falling within the scope thereof.

It shall be understood that each of the parts of the present invention may be implemented by hardware, software, firmware, or combinations thereof. In the above embodiments, multiple steps or methods may be implemented by software or firmware stored in the memory and executed by an appropriate instruction executing system. For example, if the implementation uses hardware, it may be realized by any one of the following technologies known in the art or combinations thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

Any process, method or block in the flowchart or described in other manners herein may be understood as being indicative of including one or more modules, segments or parts for realizing the codes of executable instructions of the steps in specific logic functions or processes, and that the scope of the preferred embodiments of the present invention include other implementations, wherein the functions may be executed in manners different from those shown or discussed (e.g., according to the related functions in a substantially simultaneous manner or in a reverse order), which shall be understood by a person skilled in the art.

The logic and/or steps shown in the flowcharts or described in other manners here may be, for example, understood as a sequencing list of executable instructions for realizing logic functions, which may be implemented in any computer readable medium, for use by an instruction executing system, apparatus or device (such as a system based on a computer, a system including a processor, or other systems capable of extracting instructions from an instruction executing system, apparatus or device and executing the instructions), or for use in combination with the instruction executing system, apparatus or device.

The above literal descriptions and drawings show various features of the present invention. It shall be understood that a person of ordinary skill in the art may prepare suitable computer codes to carry out each of the steps and processes described above and illustrated in the drawings. It shall also be understood that the above-described terminals, computers, servers, and networks, etc. may be any type, and the computer codes may be prepared according to the disclosure contained herein to carry out the present invention by using the apparatus.

Particular embodiments of the present invention have been disclosed herein. A person skilled in the art will readily recognize that the present invention is applicable in other environments. In practice, there exist many embodiments and implementations. The appended claims are by no means intended to limit the scope of the present invention to the above particular embodiments. Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is included in that claim.

Although a particular preferred embodiment or embodiments have been shown and the present invention has been described, it is obvious that equivalent modifications and variants are conceivable to a person skilled in the art in reading and understanding the description and drawings. Especially for various functions executed by the above elements (parts, components, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. A method for controlling a work mode, comprising:
capturing, by an electronic device, at least two images;
calculating a difference between the at least two images; and
comparing the difference between the at least two images with a predetermined first threshold, and determining whether to switch the work mode of the electronic device according to a comparison result.

2. The method according to claim 1, wherein determining whether to switch the work mode of the electronic device according to the comparison result comprises:
switching the work mode of the electronic device when the difference between the at least two images does not exceed the first threshold; and not switching the work mode of the electronic device when the difference between the at least two images exceeds the first threshold.

3. The method according to claim 1, wherein the electronic device captures the at least two images within a first predetermined time or when a predetermined condition is met.

4. The method according to claim 3, wherein capturing the at least two images within the first predetermined time by the electronic device comprises:
capturing an image at an interval of a second predetermined time within the first predetermined time.

5. The method according to claim 4, wherein calculating the difference between the at least two images comprises:
after capturing a first image and when a second image captured before the second predetermined time exists, calculating a difference between the first image and the second image

6. The method according to claim 1, further comprising:
triggering a timer to start a timing when the calculated difference between the first image and the second image does not exceed the first threshold and the timer is in a non-timing state;
resetting the timer into the non-timing state when the calculated difference between the first image and the second image exceeds the first threshold;
continuing the timing by the timer when the calculated difference between the first image and the second image does not exceed the first threshold and the timer is in a timing state; and
switching the work mode of the electronic device when the timing of the timer exceeds a second threshold.

7. The method according to claim 1, wherein the difference between the at least two images is calculated according to histograms of the images, Perceptual Hash Algorithm (PHA), image difference algorithm, image pixel color difference algorithm, Cellular Neural Network (CNN) algorithm, local wavelet descriptor algorithm, Local Binary Pattern (LBP) descriptor algorithm, image pixel grey level related algorithm, or Weber difference descriptor algorithm.

8. The method according to claim 1, wherein the electronic device captures the images under a shooting mode;
switching the work mode of the electronic device comprises: turning off the shooting mode, or switching from the normal shooting mode into a sleep mode or a power saving mode.

9. The method according to claim 1, further comprising:
judging whether detection information detected by a sensor reaches a predetermined threshold;
capturing the at least two images by the electronic device when the predetermined threshold is reached.

10. The method according to claim 1, further comprising:
judging whether a predetermined object is captured;
capturing the at least two images by the electronic device when the predetermined object is not captured.

11. An apparatus for controlling a work mode, comprising:
an capturing unit configured to capture at least two images;
a calculating unit configured to calculate a difference between the at least two images captured by the capturing unit; and
a switching unit configured to compare the difference between the at least two images with a predetermined first threshold, and determine whether to switch the work mode of the electronic device according to a comparison result.

12. The apparatus according to claim 11, wherein the switching unit is configured to:
switch the work mode of the electronic device when the difference between the at least two images does not exceed the first threshold; and not switch the work mode of the electronic device when the difference between the at least two images exceeds the first threshold.

13. The apparatus according to claim 11, wherein the capturing unit is configured to capture the at least two images within a first predetermined time or when a predetermined condition is met.

14. The apparatus according to claim 13, wherein the capturing unit further comprises:
a first capturing module configured to capture an image at an interval of a second predetermined time within the first predetermined time.

15. The apparatus according to claim 11, wherein the calculating unit further comprises:
a first calculating module configured to calculate, after the first capturing module captures a first image and when a second image captured before the second predetermined time exists, a difference between the first image and the second image.

16. The apparatus according to claim 11, further comprising:
a triggering unit configured to trigger a timer to start a timing when the difference between the first image and the second image calculated by the first calculating module does not exceed the first threshold and the timer is in a non-timing state;
a resetting unit configured to reset the timer into the non-timing state when the difference between the first image and the second image calculated by the first calculating module exceeds the first threshold;
the switching unit is further configured to switch the work mode of the electronic device when the timing of the timer exceeds a second threshold.

17. The apparatus according to claim 11, wherein the capturing unit is specifically configured to capture the images under a shooting mode;
switching the work mode of the electronic device by the switching unit specifically comprises: turning off the shooting mode, or switching from the normal shooting mode into a sleep mode or a power saving mode.

18. The apparatus according to claim 11, further comprising:
a first judging unit configured to judge whether detection information detected by a sensor reaches a predetermined threshold; and
the capturing unit captures the at least two images when a judgment result of the first judging unit shows that the predetermined threshold is reached.

19. The apparatus according to claim 11, further comprising:
a second judging unit configured to judge whether a predetermined object is captured; and
the capturing unit captures at least two images when a judgment result of the second judging unit shows that the predetermined object is not captured.

20. An electronic device, comprising an apparatus for controlling a work mode according to claim 11.
